(19) United States
(12) Patent Application Publication
(10) Pub. No.: US 2026/0067632 A1
(43) Pub. Date: Mar. 5, 2026

(54) Acoustics Processing for Nearby Spatial Audio

(71) Applicant: Apple Inc., Cupertino, CA (US)

(72) Inventors: Ronald J. Guglielmone, JR., Redwood City, CA (US); Joel N. Kerr, San Jose, CA (US); Michael J. Rockwell, Palo Alto, CA (US); Hana Z. Wang, Novato, CA (US); Danielle M. Price, Los Gatos, CA (US); Sam D. Smith, San Francisco, CA (US); Christopher T. Eubank, Santa Barbara, CA (US); Venu M. Duggineni, San Jose, CA (US); Michael D. Rosen, San Francisco, CA (US)

(21) Appl. No.: 19/248,174

(22) Filed: Jun. 24, 2025

Related U.S. Application Data
(60) Provisional application No. 63/691,212, filed on Sep. 5, 2024.

(51) Int. Cl. H04S 7/00; G06F 3/01; G06F 3/16

(52) U.S. Cl. CPC H04S 7/306; G06F 3/011; G06F 3/165; H04S 7/304; H04S 2400/11; H04S 2400/13; H04S 2400/15

(57) ABSTRACT

A first electronic device used by a first user can determine whether a second electronic device that is being used by a second user is located within a threshold distance of the first electronic device. The first electronic device may be presenting a first extended reality (XR) environment to the first user and the second electronic device may be presenting a second XR environment to the second user. The first electronic device, in response to the second electronic device being located within the threshold distance, can perform acoustics processing for nearby spatial audio. For example, the first electronic device can play a voice of the second user with a sound adjustment. Other aspects are also described and claimed.

### RELATED APPLICATIONS

This application claims the benefit of priority of U.S. Provisional Application No. 63/691,212, filed Sep. 5, 2024, which is herein incorporated by reference.

### BACKGROUND

### Field

This disclosure relates generally to acoustics processing and, more specifically, to acoustics processing for nearby spatial audio in extended reality (XR) environments. Other aspects are also described.

### Background Information

A physical environment refers to a physical world that people can sense and/or interact with or without aid of electronic devices. The physical environment may include physical features such as a physical surface or a physical object. For example, a physical environment may correspond to a physical park that includes physical trees, physical buildings, and physical people. People can directly sense and/or interact with the physical environment such as through sight, touch, hearing, taste, and smell. In contrast, an extended reality (XR) environment refers to a wholly or partially simulated environment that people sense and/or interact with via an electronic device. For example, an XR environment may include augmented reality (AR) content, mixed reality (MR) content, virtual reality (VR) content, and/or the like.

### SUMMARY

Implementations of this disclosure include utilizing a system to determine whether users are physically close to one another, within a threshold distance in a common physical environment and, when physically close, perform acoustics processing for nearby spatial audio to mitigate one or more acoustic issues. Implementations of this disclosure also include determining locations and/or directions of real and/or virtual sound sources and performing acoustics processing for nearby spatial audio based on the locations and/or directions. In various implementations, systems described herein may enable acoustics processing for nearby spatial audio, in XR environments to perform one or more of 1) sound adjustments to enable audio consistency for users in the same or different XR environments; 2) temporal crosstalk smearing; 3) dynamic audio synchronization based on background noise; 4) digital signal processing (DSP) based on crosstalk levels; and/or 5) spatial audio ducking.

Some implementations may include a method performed by a first electronic device, comprising determining by a first electronic device used by a first user whether a second electronic device that is being used by a second user is located within a threshold distance of the first electronic device, wherein the first electronic device is presenting a first XR environment to the first user and the second electronic device is presenting a second XR environment to the second user; and in response to the second electronic device being located within the threshold distance, playing via speakers of the first electronic device, in the first XR environment being presented to the first user, a voice of the second user with a sound adjustment.

Some implementations may include a method performed by a first electronic device, comprising synchronizing content for playback on a first electronic device used by a first user with the content being played back on a second electronic device that is being used by a second user to within a level of synchronization, wherein the first electronic device is presenting a first XR environment to the first user and the second electronic device is presenting a second XR environment to the second user, and wherein the first electronic device and the second electronic device are in a common physical environment; determining by the first electronic device whether the second electronic device is located within a threshold distance of the first electronic device; and in response to the second electronic device being located within the threshold distance, adjusting, based on background noise measured in the common physical environment, the level of synchronization between the first electronic device and the second electronic device.

Some implementations may include a method performed by a first electronic device, comprising determining by a first electronic device used by a first user whether a second electronic device that is being used by a second user is located within a threshold distance of the first electronic device, wherein the first electronic device is presenting a first XR environment to the first user and the second electronic device is presenting a second XR environment to the second user; in response to the second electronic device being located within the threshold distance, tuning an output audio signal based on a parameter having a measurement including the first electronic device and the second electronic device; and transmitting the tuned output audio signal to speakers of the first electronic device for playback.

Some implementations may include a method performed by a first electronic device, comprising determining by a first electronic device used by a first user whether a second electronic device that is being used by a second user is located within a threshold distance of the first electronic device, wherein the first electronic device is presenting a first XR environment to the first user and the second electronic device is presenting a second XR environment to the second user; and in response to the second electronic device being located within the threshold distance, playing, via speakers of the first electronic device, a plurality of reflections to mask an echo caused by a voice of the second user or the second electronic device as picked up by a microphone of the first electronic device.

Some implementations may include a method performed by a first electronic device, comprising determining by a first electronic device used by a first user a location or direction of a sound source emitting a sound to the first user, wherein the first electronic device is presenting a first XR environment to the first user; and in response to the sound source emitting the sound, modifying an output to one or more virtual speakers of a plurality of virtual speakers surrounding the first user in a spatial environment, relative to other virtual speakers of the plurality of virtual speakers, based on a location or direction of the sound source. Other aspects are also described and claimed.

The above summary does not include an exhaustive list of all aspects of the present disclosure. It is contemplated that the disclosure includes all systems and methods that can be practiced from all suitable combinations of the various aspects summarized above, as well as those disclosed in the Detailed Description below and particularly pointed out in the Claims section. Such combinations may have particular advantages not specifically recited in the above summary.

### BRIEF DESCRIPTION OF THE DRAWINGS

Several aspects of the disclosure here are illustrated by way of example and not by way of limitation in the figures of the accompanying drawings in which like references indicate similar elements. It should be noted that references to “an” or “one” aspect in this disclosure are not necessarily to the same aspect, and they mean at least one. Also, in the interest of conciseness and reducing the total number of figures, a given figure may be used to illustrate the features of more than one aspect of the disclosure, and not all elements in the figure may be required for a given aspect.

FIG. 1 is an example of a system providing acoustics processing for nearby spatial audio in XR environments.

FIG. 2 is an example of an electronic device presenting an XR environment.

FIG. 3 is an example of a graph illustrating a sound having a direct path and reverberation.

FIG. 4 is an example of a system providing acoustics processing for nearby spatial audio in XR environments based on measured background noise.

FIG. 5 is an example of a system providing acoustics processing for nearby spatial audio in XR environments based on tuning an output audio signal.

FIG. 6 is an example of an impulse response with an echo.

FIG. 7 is an example of an impulse response with masking of an echo.

FIG. 8A is an example of a system modifying an output to a virtual speaker; and FIG. 8B is an example of a system modifying an output to virtual speakers of a speaker cone.

FIG. 9 is an example of a process for acoustics processing for nearby spatial audio with a sound adjustment of a voice of a user.

FIG. 10 is an example of a process for acoustics processing for nearby spatial audio based on measured background noise.

FIG. 11 is an example of a process for acoustics processing for nearby spatial audio based on tuning an output audio signal.

FIG. 12 is an example of a process for acoustics processing for nearby spatial audio based on masking echoes.

### DETAILED DESCRIPTION

A user can utilize an electronic device, such as a head mounted display (HMD) system having speakers, a microphone, and a display, to immerse themselves in an XR environment. In some cases, multiple users can utilize devices to receive synchronized content between them. Further, the users can receive the content while in a common XR environment or in different XR environments. For example, the users might join one another to play a VR game while immersed in a common XR environment corresponding to a game environment. In another example, the users might join one another to watch a video or communicate with each other via windowed content while each user is immersed in their own XR environment (e.g., one user may be immersed in a virtual office building, and another user be immersed in a virtual park, while the users each view a window playing a synchronized video).

In some cases, the users may be together in a common physical environment, such as sitting next to each other on a couch in a room. When the users are physically together while using their devices to communicate with one another and/or while receiving synchronized content (e.g., when the users are co-located), it is possible that the users could experience one or more acoustic issues due to nearby spatial audio. For example, in some cases, the users might not hear each other properly through their headsets, because they already hear each other in the common physical environment. Also, in some cases, the user's devices might pick up undesirable acoustic crosstalk generated by other devices in the common physical environment. In some cases, the acoustic crosstalk can cause a single slap-back echo to be heard by the users through their devices. Further, in some cases, the users might not perceive each other in their XR environments due to mismatches in voice reverberations.

Implementations of this disclosure address problems such as these by utilizing a system to determine whether users are physically close to one another, within a threshold distance in a common physical environment and, when physically close, perform acoustics processing for nearby spatial audio to mitigate one or more of the acoustic issues. Implementations of this disclosure also include determining locations and/or directions of real and/or virtual sound sources and performing acoustics processing for nearby spatial audio based on the locations and/or directions. In various implementations, systems described herein may enable acoustics processing for nearby spatial audio, in XR environments to perform one or more of 1) sound adjustments to enable audio consistency for users in the same or different XR environments; 2) temporal crosstalk smearing; 3) dynamic audio synchronization based on background noise; 4) DSP based on crosstalk levels; and/or 5) spatial audio ducking.

In some implementations, if one or more users are joined in a system environment, a system can add an artificial reverberation tail onto their local peers for consistency. This reverberation tail can be time-aligned with a user's physical voice to bring the user into the system environment of another.

In some implementations, to reduce acoustic crosstalk, two or more devices can be synchronized while consuming the same audio-visual content in the common physical environment. The system can dynamically change inter-device synchronization as a function of background noise, loosening synchronization, when possible, to reduce power consumption and increase battery life.

In some implementations, the system can dynamically tune the output audio signal of a device based on one or more parameters involving each of the devices, such as output level differences, physical distance, synchronization drift, and/or background noise in the environment. For example, the system can tune dynamic range compression and/or equalization parameters to reduce bothersome audible effects of acoustic crosstalk between devices.

In some implementations, when acoustic crosstalk between devices may be heard as a single slap-back echo, each device can convolve a playback signal with a predefined impulse response to cause the single slap-back echo to become part of multiple synthesized, early reflections. This may cause the acoustic crosstalk to be perceived by a user as reverberation rather than a stark delay (e.g., temporal crosstalk smearing).

In some implementations, the system can dynamically perform spatial audio ducking of applications based on sound sources, such as a voice of a user (e.g., a physical sound source) or a notification from a virtual window (e.g., a virtual sound source). The system can dynamically change a direct to reverberant ratio (DRR) or gain of one or more virtual speakers to make a sound more audible to the user and/or more reverberant.

Several aspects of the disclosure with reference to the appended drawings are now explained. Whenever the shapes, relative positions and other aspects of the parts described are not explicitly defined, the scope of the invention is not limited only to the parts shown, which are meant merely for the purpose of illustration. Also, while numerous details are set forth, it is understood that some aspects of the disclosure may be practiced without these details. In other instances, well-known circuits, structures, and techniques have not been shown in detail so as not to obscure the understanding of this description.

With an XR system, a subset of a person's physical motions, or representations thereof, are tracked, and, in response, one or more characteristics of one or more virtual objects simulated in the XR environment are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

There are many different types of electronic systems that enable a person to sense and/or interact with various XR environments. Examples include head mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mountable system may have one or more speaker(s) and an integrated opaque display. Alternatively, a head mountable system may be configured to accept an external opaque display (e.g., a smartphone). The head mountable system may incorporate one or more imaging sensors to capture images or video of the physical environment, and/or one or more microphones to capture audio of the physical environment. Rather than an opaque display, a head mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

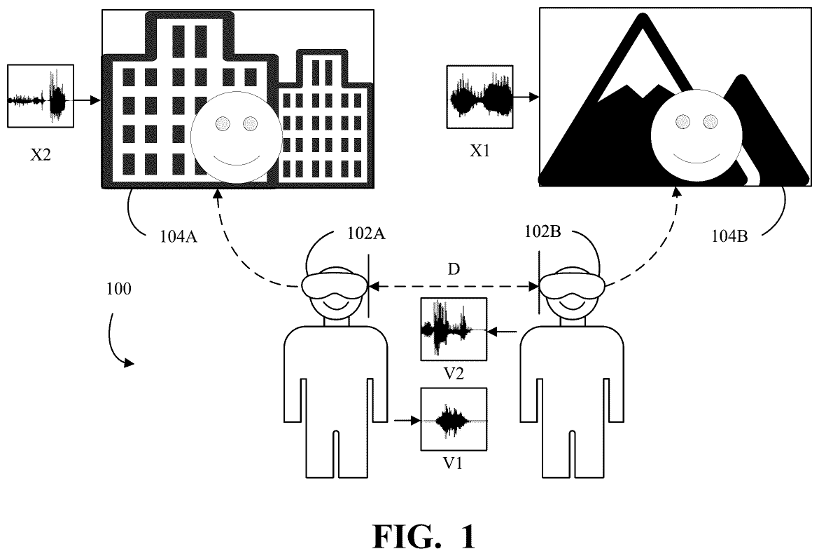

FIG. 1 is an example of a system 100 providing acoustics processing for nearby spatial audio in XR environments. The system 100 may include a first electronic device 102A used by a first user and a second electronic device 102B used by a second user. While two electronic devices are shown by way of example (each a local peer), additional electronic devices used by additional users may be present in the system 100 (e.g., a third electronic device used by a third user in a different physical environment or room). The first electronic device 102A may be presenting a first XR environment 104A to the first user, and the second electronic device 102B may be presenting a second XR environment 104B to the second user. For example, each electronic device could comprise an HMD configured to immerse the user in an XR environment.

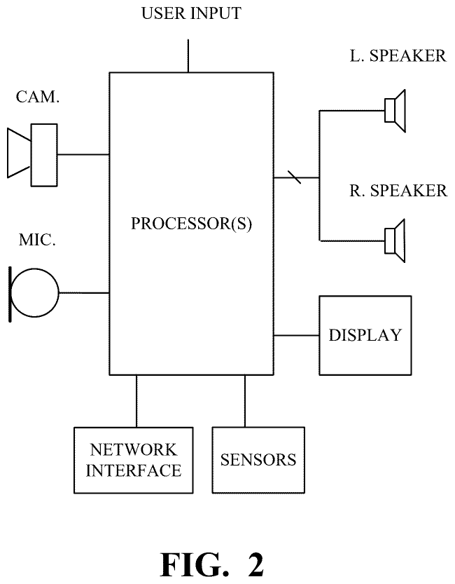

With additional reference to FIG. 2, the first electronic device 102A and the second electronic device 102B could each be an electronic device that includes one or more of the structures shown. The structures may include, for example, one or more processors (e.g., to execute instructions), memories, displays (e.g., to present an XR environment to the user), speakers (e.g., physical speakers, such as left and right speakers for left and right ears of the user, respectively, or virtual speakers that may be positioned in a spatial environment of the user), microphones (e.g., local microphones, including to pick up a voice of the user of the electronic device, and/or ambient microphones, including to pick up sounds in the environment of the user, such as voices of other users), cameras (e.g., to detect images in the environment, including another electronic device, via computer imaging), other sensors (e.g., Lidar to detect distances to objects, including other electronic devices), user inputs (e.g., wireless controllers, volume and/or mute buttons, etc.), and/or a network interfaces (e.g., to enable the electronic device to connect to other electronic devices directly, peer to peer, or indirectly via a server, to share the synchronized content). The one or more processors may execute instructions stored in memory to enable the device to perform acoustics processing for nearby spatial audio as described herein. For example, the device can execute instructions in memory to perform one or more of 1) sound adjustments to enable audio consistency for users in the same or different XR environments; 2) temporal crosstalk smearing; 3) dynamic audio synchronization based on background noise; 4) DSP based on crosstalk levels; and/or 5) spatial audio ducking, including based on utilization of virtual speakers.

Referring again to FIG. 1, in some cases, some users of the electronic devices may be together in a common physical environment, such as sitting next to each other on a couch in a room (e.g., the users may be co-located). The users may be speaking to one another in the common physical environment (e.g., their physical voices reflecting from walls in the room), including while utilizing their devices to communicate via their speakers and microphones, and while receiving synchronized content between their devices (e.g., shared content, such as a joined conference call or telephony, a shared movie, video, music, etc.). For example, a voice V1 of the first user may be heard by the second user (e.g., directly via a direct path, and indirectly via reflections in the room), including while the second user is utilizing speakers and microphones of the second electronic device 102B to communicate with the first user, and while the second electronic device 102B is receiving the synchronized content. Also, a voice V2 of the second user may be heard by the first user (e.g., directly via a direct path, and indirectly via reflections in the room), including while the first user is utilizing speakers and microphones of the first electronic device 102A to communicate with the second user, and while the first electronic device 102A is receiving the synchronized content.

Further, the users can receive the synchronized content while in a common (same) XR environment or while in different XR environments. For example, to play a game or share an experience with one another, the users can join in a common XR environment that provides the game experience. Moreover, in some cases, the common XR environment can cause the first electronic device 102A and the second electronic device 102B to produce the same acoustic properties, such as a same amount of reverberation for each device (e.g., same gains or DRR to speakers), corresponding to the common XR environment being shared.

In another example, the users can receive the synchronized content while in different XR environments. For example, each user can immerse themselves in their own XR environments, such as the first user utilizing the first electronic device 102A to immerse in the first XR environment 104A, e.g., a virtual office environment, and the second user utilizing the second electronic device 102B to immerse in the second XR environment 104B, e.g., a virtual park environment. Moreover, the different XR environments may cause the first electronic device 102A and the second electronic device 102B to produce different acoustic properties (e.g., different gains or DRR to speakers), such as a greater amount of reverberation for the first electronic device 102A (corresponding to the virtual office) and a lesser amount of reverberation for the second electronic device 102B (corresponding to the virtual park). The users can each immerse themselves in their respective XR environments while viewing a window playing the synchronized content between the devices.

To mitigate one or more of the acoustic issues described herein, the first electronic device 102A and/or the second electronic device 102B may perform acoustics processing for nearby spatial audio, in the device's XR environment. For example, with respect to the first user, the first electronic device 102A can perform acoustics processing for nearby spatial audio in the first XR environment 104A. The processing may include determining by the first electronic device 102A whether the second electronic device 102B is located within a threshold distance D of the first electronic device 102A (e.g., within 3 meters). In response to the second electronic device 102B being located within the threshold distance D, the first electronic device 102A can play via its speakers (physical or virtual), for the user in the first XR environment 104A, the voice of the second user with a sound adjustment X2 based on the location of the second user and/or the second electronic device 102B. For example, the sound adjustment X2 may include suppressing a direct path, and/or adding, retaining, or modifying a reverberation tail, of the voice of the second user, transmitted via a microphone of the second electronic device 102B, through a network according to a networking protocol, and received through speakers of the first electronic device 102A. Similarly, with respect to the second user, the second electronic device 102B can perform acoustics processing for nearby spatial audio in the second XR environment 104B for the second user (e.g., the voice of the first user can be played with a sound adjustment X2, based on the location of the first user and/or the first electronic device 102A).

In contrast, the first electronic device 102A might determine that a third electronic device being used by a third user (not shown) is located outside of the threshold distance D of the first electronic device 102A. For example, the third user, also receiving the synchronized content via their device, may be further away in the room (e.g., 10 meters away), or in another room, building, or location entirely. In response to the third electronic device being located outside of the threshold distance D, the first electronic device 102A can play via the speakers, for the user in the first XR environment 104A, a voice of the third user without causing the sound adjustment (e.g., leaving a direct path and/or reverberation tail of the voice unchanged).

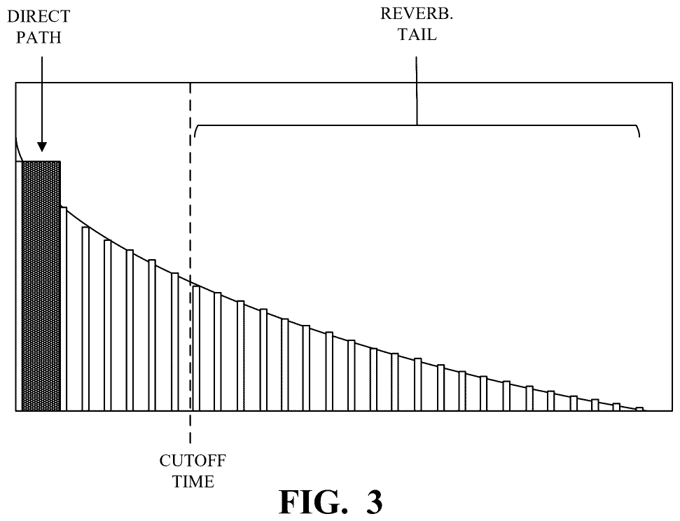

Thus, in some implementations, the sound adjustment can suppress a direct path of the voice of the other user as picked up by a microphone of the electronic device. The sound adjustment can also add or retain a reverberation tail of the voice of the other user. For example, with additional reference to FIG. 3, a graph illustrates a sound (e.g., a voice of a user uttered in a physical environment) having a direct path and reverberation. The reverberation may include a reverberation tail that occurs after the direct path of the sound and after a cutoff time that may be configurable by the device.

Referring again to FIG. 1, with respect to the first user, the first electronic device 102A can generate the sound adjustment X2 to suppress (via DSP) the direct path of the voice of the second user as picked up by the microphone of the second electronic device 102B and transmitted to the speakers (physical and/or virtual) of the first electronic device 102A. The first electronic device 102A can also generate the sound adjustment X2 to add (artificially generate), retain, and/or modify (via DSP) the reverberation tail of the voice of the second user as transmitted to the speakers. In some cases, the first electronic device 102A can modify the reverberation tail of the voice to simulate acoustically (for the first user) that the second user is talking in the first XR environment 104A (e.g., the virtual office environment where more reverberation may be present). The second electronic device 102B can generate the sound adjustment X1 similarly for the second user in the second XR environment 104B (e.g., to simulate acoustically (for the second user) that the first user is talking in the second XR environment 104B, the virtual park where less reverberation may be present).

Further, in some cases, the first electronic device 102A can generate the sound adjustment X2 to suppress the direct path of the voice of the second user to one or more speakers, such as the left speaker or the right speaker of the headset connected to the first electronic device 102A. This may include attenuating the DRR or gain, or ducking, the speaker based on detecting the voice V2 (e.g., via an ambient microphone). The first electronic device 102A can suppress the direct path to the corresponding speaker based on the location and/or direction of the second user and/or the second electronic device 102B. For example, if the second user and/or the second electronic device 102B is detected to the left of the first electronic device 102A, and within the threshold distance D, the first electronic device 102A can suppress the direct path transmitted via the left speaker of the first electronic device 102A. The second user and/or the second electronic device 102B may be detected, for example, by utilizing the cameras, microphones, and/or other sensors of the first electronic device 102A.

In some cases, the first electronic device 102A can generate the sound adjustment X2 to modify an output to one or more virtual speakers relative to other virtual speakers in a spatial environment surrounding the first user. This may include the first electronic device 102A modifying the output (e.g., DRR or gain) based on the location and/or direction of the second user and/or the second electronic device 102B. For example, if the second user and/or the second electronic device 102B are detected to the left of the first electronic device 102A, and within the threshold distance D, the first electronic device 102A can modify an output to one or more virtual speakers to the left to dynamically reduce the DRR or gain of those speakers, including relative to other virtual speakers, such as one or more virtual speakers to the right or above the first user (which maintain their DRR or gains).

In some implementations, the first electronic device 102A can generate the sound adjustment X2 to include a reverberation tail of the voice of the second user (transmitted to the speakers) that is time-aligned and/or superimposed with the voice V2 of the second user in the physical environment. In some cases, the first electronic device 102A can utilize an ambient microphone to detect the voice V2 of the second user in the physical environment to perform the time alignment and/or super position.

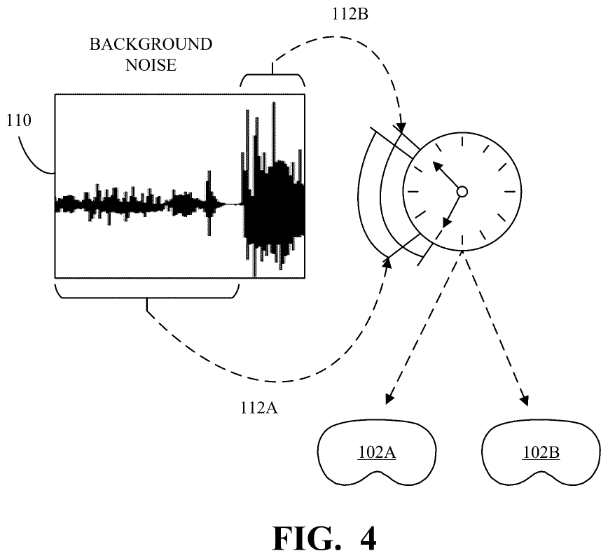

In some implementations, to reduce acoustic crosstalk, two or more devices can be synchronized while consuming the same audio-visual content in the common physical environment. The system can dynamically change inter-device synchronization as a function of background noise, loosening synchronization, when possible, to reduce power consumption and increase battery life. For example, FIG. 4 illustrates a system providing acoustics processing for nearby spatial audio in XR environments based on measured background noise. The first electronic device 102A (discussed above with respect to FIG. 1) can synchronize content for playback with content being played back on the second electronic device 102B (e.g., shared content). The first electronic device 102A can synchronize the content to within a level of synchronization. The first electronic device 102A can determine whether the second electronic device 102B is located within the threshold distance D of the first electronic device 102A. In response to the second electronic device 102B being located within the threshold distance D, the first electronic device 102A can adjust, based on background noise 110 measured in the common physical environment (e.g., the room in which the first user and the second user are co-located), the level of synchronization between the first electronic device 102A and the second electronic device 102B.

The level of synchronization can be loosened or lowered with more background noise and tightened or raised with less background noise. For example, during a first period 112A, corresponding to less background noise measured in the common physical environment, the first electronic device 102A can increase the level of synchronization of the content with the second electronic device 102B (e.g., the level of synchronization is tightened or raised). Then, during a second period 112B, corresponding to more background noise measured in the common physical environment, the first electronic device 102A can decrease the level of synchronization of the content with the second electronic device 102B (e.g., the level of synchronization is loosened or lowered). Loosening or lowering the level of synchronization may enable the first electronic device 102A to operate in a mode having a reduction in power consumption.

In some implementations, the level of synchronization may be adjusted by changing from a first networking protocol to a second networking protocol for communication between the first electronic device 102A and the second electronic device 102B. For example, during the first period 112A, the first electronic device 102A can utilize the first networking protocol (e.g., Apple Wireless Direct Link, having a lower latency) to communicate the synchronized content with the second electronic device 102B. Then, during the second period 112B, the first electronic device 102A can utilize the second networking protocol (e.g., Ethernet, having a higher latency) to communicate the synchronized content with the second electronic device 102B.

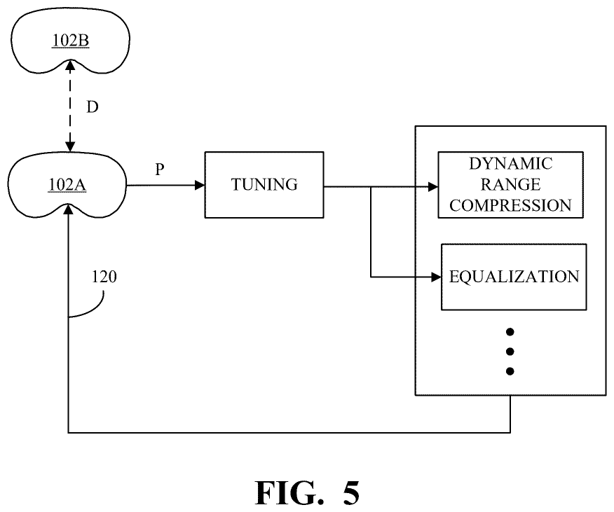

In some implementations, the system can dynamically tune the output audio signal of a device (e.g., to one or more physical and/or virtual speakers) based on one or more parameters involving each of the devices, such as output level differences, physical distance, synchronization drift, and/or background noise in the environment. In some cases, the system can tune dynamic range compression and/or equalization parameters to reduce bothersome audible effects of acoustic crosstalk between devices. For example, FIG. 5 illustrates a system providing acoustics processing for nearby spatial audio in XR environments based on tuning an output audio signal 120. The first electronic device 102A (discussed above with respect to FIG. 1) can determine whether the second electronic device 102B is located within the threshold distance D of the first electronic device 102A. In response to the second electronic device 102B being located within the threshold distance D, the first electronic device 102A can tune the output audio signal 120 based on a parameter P having a measurement including the first electronic device 102A and the second electronic device 102B. For example, the parameter P may include an output audio level difference, a synchronization difference, or a physical distance measured between the first electronic device 102A and the second electronic device 102B. In another example, the parameter P may include a measured background noise in the physical environment that includes both the first electronic device 102A and the second electronic device 102B (e.g., the room). Tuning the output audio signal 120 may include changing a dynamic range compression and/or an equalization. The first electronic device 102A can transmit the tuned output audio signal 120 to one or more speakers (physical or virtual) of the first electronic device 102A for playback.

In some implementations, the speakers may include a left speaker and a right speaker of a headset connected to the first electronic device (e.g., physical speakers). Tuning the output audio signal 120 may include ducking either the left speaker or the right speaker based on detecting a voice of the second user in the physical environment (e.g., utilizing one or more microphones). In some implementations, the speakers may include virtual speakers in a spatial environment surrounding the first user. Tuning the output audio signal 120 may include attenuating a DRR or gain of one or more of the virtual speakers relative to other virtual speakers in the spatial environment based on a location and/or direction of the second electronic device 102B and/or the second user.

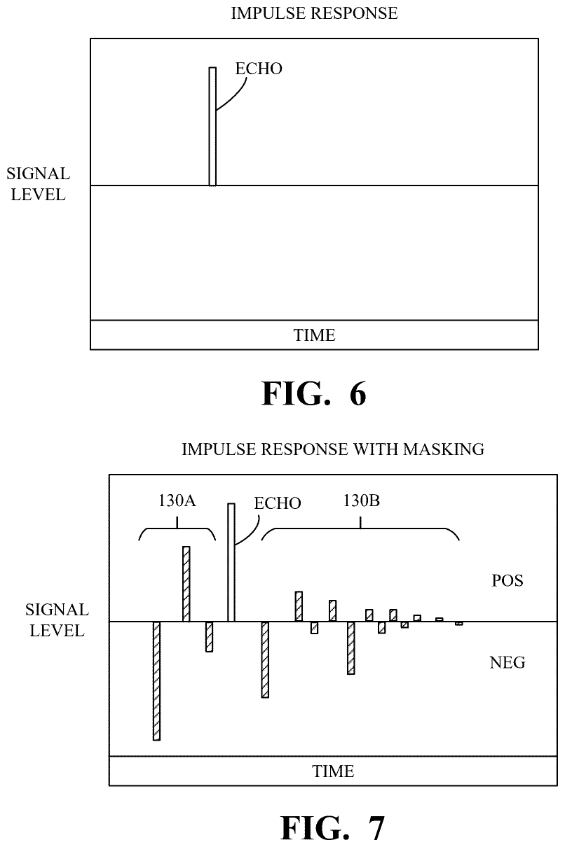

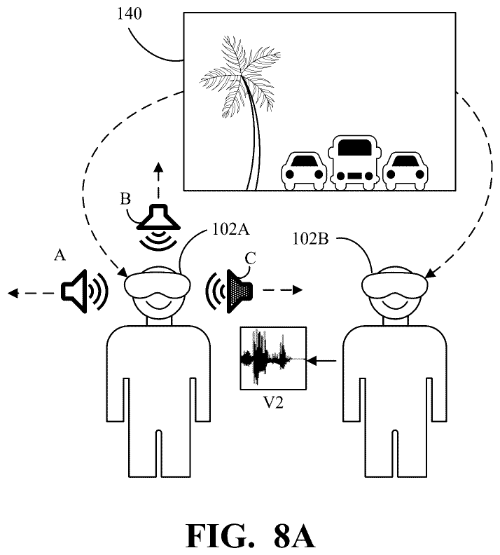

In some implementations, when acoustic crosstalk between devices may be heard as a single slap-back echo, each device can convolve a playback signal with a predefined impulse response to cause the single slap-back echo to become part of multiple synthesized, early reflections (e.g., before the cutoff time). This may cause the acoustic crosstalk to be perceived by a user as reverberation rather than a stark delay (e.g., temporal crosstalk smearing). For example, FIG. 6 illustrates an impulse response with an echo that may be experienced by a system. In contrast, FIG. 7 illustrates an example of an impulse response with masking of an echo, performed by the first electronic device 102A. The first electronic device 102A (discussed above with respect to FIG. 1) can determine whether the second electronic device 102B is located within the threshold distance D of the first electronic device 102A. In response to the second electronic device 102B being located within the threshold distance D, the first electronic device 102A can play via speakers (physical or virtual), for the user in the first XR environment 104A, a plurality of reflections to mask the echo caused by the voice of the second user, as picked up by a microphone of the first electronic device 102A.

The plurality of reflections may include one or more early reflections 130A before the echo and one or more late reflections 130B after the echo. The plurality of reflections may also include one or more positive reflections, having positive magnitudes, with the echo, and one or more negative reflections having negative magnitudes opposing the echo. In some cases, the plurality of reflections may be determined by the first electronic device 102A based on a physical distance between the first electronic device and the second electronic device. For example, the first electronic device 102A can adjust quantities, magnitudes, and/or timings of reflections, based on the measured distance between the devices.

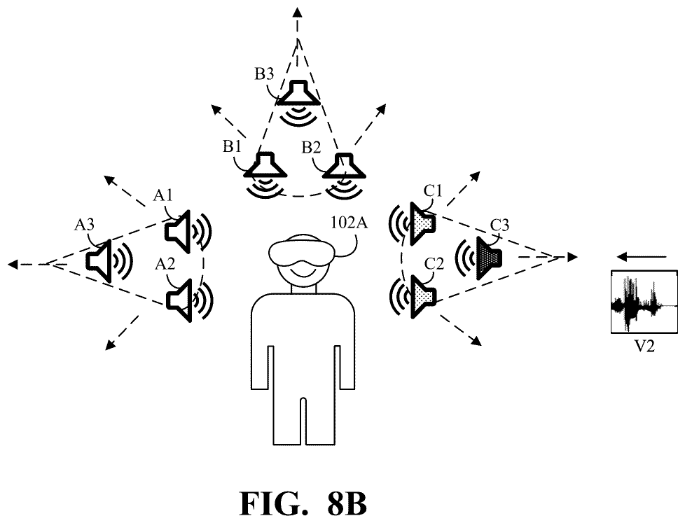

In some implementations, the system can dynamically perform spatial audio ducking of applications based on sound sources, such as a voice of a user (e.g., a physical sound source) or a notification from a virtual window (e.g., a virtual sound source). The system can dynamically change a DRR or gain of one or more physical or virtual speakers to make a sound more audible to the user and/or more reverberant. For example, FIG. 8A illustrates an example of a system modifying an output to a virtual speaker (e.g., an output audio signal). The first electronic device 102A (discussed above with respect to FIG. 1) can configure a plurality of virtual speakers surrounding the first user in a spatial environment, such as speaker A positioned 1 meter to the right of the first user, speaker B positioned 1 meter above the first user, and speaker C positioned 1 meter to the left of the first user. The first user can utilize the plurality of virtual speakers in the first XR environment, including to communicate the synchronized content with the second electronic device 102B (e.g., shared content, such as a joined conference call or telephony, a shared movie, video, music, etc., in a window 140 of the XR environments).

The first electronic device 102A can then determine a location and/or direction of a sound source emitting a sound to the first user (e.g., the voice V2 of the second user). In response to the sound source emitting the sound, the first electronic device 102A can modify an output to one or more virtual speakers of a plurality of virtual speakers surrounding the first user, relative to other virtual speakers of the plurality of virtual speakers, based on the location and/or direction of the sound source. For example, the first electronic device 102A can modify an output to speaker C on the left, relative to speakers A and B, based on the second user and/or the second electronic device 102B being located on the left. The modification may include attenuating the DRR or gain of speaker C to enable a pathway for the sound (the voice V2) directly to the first user, including while maintaining the DRR or gain of speakers B and C.

In some implementations, the sound source may be a notification window in the first XR environment. For example, the sound could be a chime associated with a window that the first user has virtually placed in the first XR environment. The modification may include attenuating the DRR or gain of a virtual speaker in a path of the notification window, to enable a pathway for the sound (the chime) directly to the first user, including while maintaining the DRR or gain of other virtual speakers that are not in a path of the notification window (or attenuating those speakers for other sounds).

In some implementations, one or more virtual speakers may define a three dimensional virtual speaker cone oriented toward the location or direction, and modifying the output can cause DRR or gains to the one or more virtual speakers to be attenuated differently based on positions of the one or more virtual speakers in the virtual cone. For example, referring to FIG. 8B, speaker C on the left of the first user could be a speaker cone C that includes speakers C1 and C2, closer to the first user while being spaced apart, and speaker C3, further from the first user and closer to the second user. The speakers C1, C2 and C3, forming speaker cone C on the left, may at times be oriented toward a sound source, such as the voice V2 of the second user. Similarly, speaker A on the right of the first user could be a speaker cone A (including speakers A1, A2 and A3), and speaker B above the first user could be a speaker cone B (including speakers B1, B2 and B3). The first electronic device 102A can modify the output differently to one or more speakers of a speaker cone based on the detected sound, such as attenuating speaker C3 more, and speakers C1 and C2 less, to enable a pathway for the sound (the voice V2) directly to the first user (while maintaining the output of speaker cones B and C or attenuating speakers of those cones for other sounds).

In some implementations, positions of the one or more virtual speakers and/or speaker cones may be moved outward relative to the first user to enable a pathway for direct sound from the sound source. For example, the modification may include moving one or more of the plurality of speakers further outward, such as moving each of speakers A, B, and C from 1 meter away from the first user to 1.5 meters away from the first user, to enable a pathway for the sound (the voice V2) directly to the first user.

Reference is now made to flowcharts of examples of processes for acoustics processing for nearby spatial audio in XR environments. The processes can be executed using computing devices, such as the systems, hardware, and software described with respect to FIGS. 1-8. The processes can be performed, for example, by executing a machine-readable program or other computer-executable instructions, such as routines, instructions, programs, or other code. The operations of the processes or other techniques, methods, or algorithms described in connection with the implementations disclosed herein can be implemented directly in hardware, firmware, software executed by hardware, circuitry, or a combination thereof.

For simplicity of explanation, the processes are depicted and described herein as a series of operations. However, the operations in accordance with this disclosure can occur in various orders and/or concurrently. Additionally, other operations not presented and described herein may be used. Furthermore, not all illustrated operations may be required to implement a process in accordance with the disclosed subject matter.

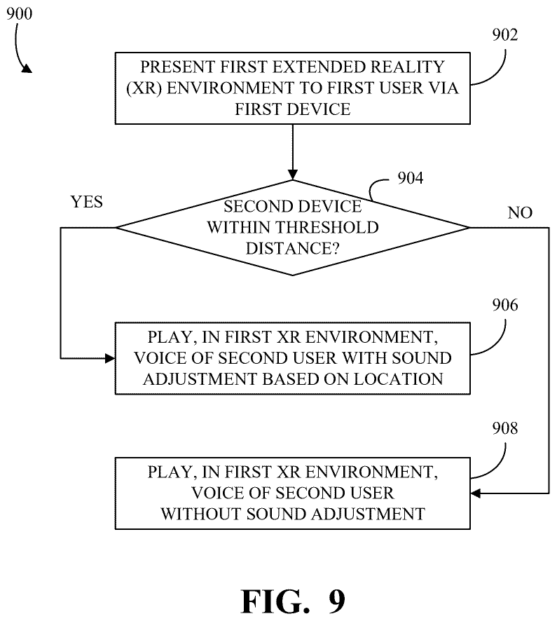

FIG. 9 is an example of a process 900 for acoustics processing for nearby spatial audio with a sound adjustment of a voice of a user. At operation 902, the first electronic device 102A used by the first user can present the first XR environment 104A to the first user. At operation 904, the first electronic device 102A can determine whether the second electronic device 102B that is being used by the second user is located within the threshold distance D of the first electronic device 102A. The second electronic device 102B may be presenting the second XR environment 104B to the second user. If the second electronic device 102B is located within the threshold distance D (“Yes”), at operation 906, the first electronic device 102A can play via speakers (physical or virtual) of the first electronic device 102A, in the first XR environment 104A being presented to the first user, a voice of the second user with a sound adjustment X2. However, if the second electronic device 102B is not located within the threshold distance D of the first electronic device 102A (“No”), and instead is located outside of the threshold distance D, at operation 908, the first electronic device 102A can play via the speakers, in the first XR environment 104A, the voice without the sound adjustment X2.

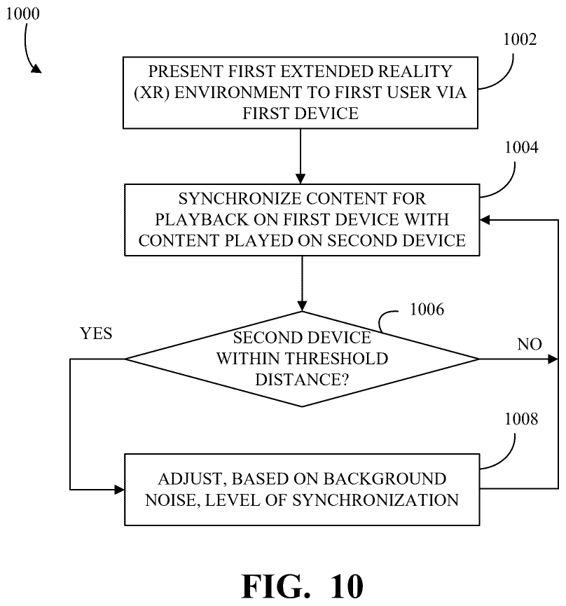

FIG. 10 is an example of a process 1000 for acoustics processing for nearby spatial audio based on measured background noise. At operation 1002, the first electronic device 102A used by the first user can present the first XR environment 104A to the first user. At operation 1004, the first electronic device 102A can synchronize content for playback on the first electronic device 102A with the content being played back on the second electronic device 102B that is being used by the second user to within a level of synchronization. The first electronic device 102A and the second electronic device 102B may be in a common physical environment (e.g., co-located in a room), and the second electronic device 102B may be presenting the second XR environment 104B to the second user. At operation 1006, the first electronic device 102A can determine whether the second electronic device 102B is located within the threshold distance D of the first electronic device 102A. If the second electronic device 102B is not located within the threshold distance D of the first electronic device 102A (“No”), and instead is located outside of the threshold distance D, the process 900 can return to operation 1004. However, if the second electronic device 102B is located within the threshold distance D of the first electronic device 102A (“Yes”), at operation 1008, the first electronic device 102A can adjust, based on background noise measured in the common physical environment, the level of synchronization between the first electronic device 102A and the second electronic device 102B. The process 1000 can then return to operation 1004 to continue synchronizing content for playback based on the adjustment.

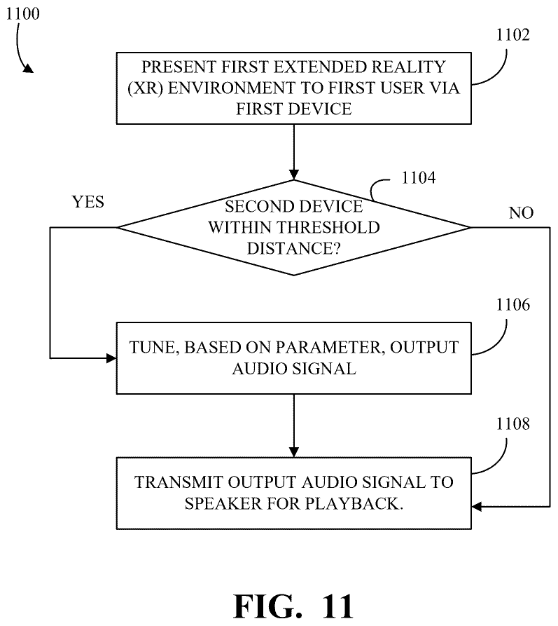

FIG. 11 is an example of a process 1100 for acoustics processing for nearby spatial audio based on tuning an output audio signal. At operation 1102, the first electronic device 102A used by the first user can present the first XR environment 104A to the first user. At operation 1104, the first electronic device 102A can determine whether the second electronic device 102B that is being used by the second user is located within the threshold distance D of the first electronic device 102A. The second electronic device 102B may be presenting the second XR environment 104B to the second user. If the second electronic device 102B is located within the threshold distance D of the first electronic device 102A (“Yes”), at operation 1106, the first electronic device 102A can measure a parameter P involving each of the first electronic device 102A and the second electronic device 102B. Further, the first electronic device 102A can tune (e.g., change one or more dynamic range compression and/or equalization parameters) one or more output audio signals 120 to one or more speakers (physical or virtual) based on the parameter P. Then, at operation 1108, the first electronic device 102A can transmit the tuned output audio signals 120 to speakers (physical or virtual) of the first electronic device 102A for playback in the first XR environment 104A. However, if at operation 1104, the first electronic device 102A determines that the second electronic device 102B is not located within the threshold distance D of the first electronic device 102A (“No”), and instead is located outside of the threshold distance D, the process 1100 can continue to operation 1108 to transmit the output audio signals 120, without additional tuning, to speakers of the first electronic device 102A for playback in the first XR environment 104A (e.g., the process 1100 can bypass operation 1106).

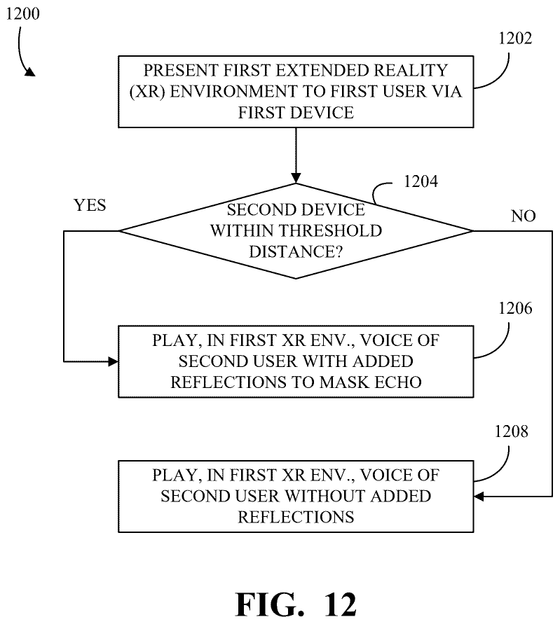

FIG. 12 is an example of a process 1200 for acoustics processing for nearby spatial audio based on masking echoes. At operation 1202, the first electronic device 102A used by the first user can present the first XR environment 104A to the first user. At operation 1204, the first electronic device 102A can determine whether the second electronic device 102B that is being used by the second user is located within a threshold distance D of the first electronic device 102A. The second electronic device 102B may be presenting the second XR environment 104B to the second user. If the second electronic device 102B is located within the threshold distance D of the first electronic device 102A (“Yes”), at operation 1206, the first electronic device 102A can play via speakers (physical or virtual) of the first electronic device 102A, in the first XR environment 104A, a plurality of reflections (e.g., one or more early reflections 130A and/or late reflections 130B) representing reverberation of the voice of the second user. The plurality of reflections can mask an echo caused by the voice of the second user or the second electronic device 102B as picked up by a microphone of the first electronic device 102A. However, if the second electronic device 102B is not located within the threshold distance D of the first electronic device 102A (“No”), and instead is located outside of the threshold distance D, at operation 1208, the first electronic device 102A can play via speakers of the first electronic device 102A, in the first XR environment 104A, the voice of the second user without the plurality of reflections.

Some implementations may include a method performed by a first electronic device, comprising determining by a first electronic device used by a first user whether a second electronic device that is being used by a second user is located within a threshold distance of the first electronic device, wherein the first electronic device is presenting a first XR environment to the first user and the second electronic device is presenting a second XR environment to the second user; and in response to the second electronic device being located within the threshold distance, playing via speakers of the first electronic device, in the first XR environment being presented to the first user, a voice of the second user with a sound adjustment. In some embodiments, the sound adjustment a) suppresses a direct path of the voice of the second user as picked up by a microphone of the second electronic device, and b) adds or retains a reverberation tail of the voice of the second user. In some embodiments, the first XR environment is different from the second XR environment, and wherein the sound adjustment modifies a reverberation tail of the voice of the second user, as picked up by a microphone of the second electronic device, to simulate acoustically that the second user is talking in the first XR environment. In some embodiments, the sound adjustment includes a reverberation tail of the voice of the second user that is time-aligned with a voice of the second user in a physical environment that includes both the first electronic device and the second electronic device. In some embodiments, the sound adjustment suppresses a direct path of the voice of the second user to either a left speaker or a right speaker of a headset connected to the first electronic device based on a location or direction of the second electronic device or the second user. In some embodiments, the sound adjustment includes a reverberation tail of the voice of the second user superimposed with a physical reverberation of the voice of the second user in a physical environment that includes both the first electronic device and the second electronic device. In some embodiments, the method includes playing, in response to a third electronic device used by a third user being located outside of the threshold distance, a direct path followed by a reverberation tail of a voice of the third user in the first XR environment. In some embodiments, the speakers are virtual speakers in a spatial environment surrounding the first user, and wherein an output to one or more of the virtual speakers is modified relative to other virtual speakers in the spatial environment based on a location or direction of the second electronic device or the second user.

Some implementations may include a method performed by a first electronic device, comprising synchronizing content for playback on a first electronic device used by a first user with the content being played back on a second electronic device that is being used by a second user to within a level of synchronization, wherein the first electronic device is presenting a first XR environment to the first user and the second electronic device is presenting a second XR environment to the second user, and wherein the first electronic device and the second electronic device are in a common physical environment; determining by the first electronic device whether the second electronic device is located within a threshold distance of the first electronic device; and in response to the second electronic device being located within the threshold distance, adjusting, based on background noise measured in the common physical environment, the level of synchronization between the first electronic device and the second electronic device. In some embodiments, the level of synchronization is adjusted by changing from a first networking protocol to a second networking protocol for communication between the first electronic device and the second electronic device. In some embodiments, the level of synchronization is loosened or lowered with more background noise and tightened or raised with less background noise. In some embodiments, loosening or lowering the level of synchronization enables a reduction in power consumption by the first electronic device.

Some implementations may include a method performed by a first electronic device, comprising determining by a first electronic device used by a first user whether a second electronic device that is being used by a second user is located within a threshold distance of the first electronic device, wherein the first electronic device is presenting a first XR environment to the first user and the second electronic device is presenting a second XR environment to the second user; in response to the second electronic device being located within the threshold distance, tuning an output audio signal based on a parameter having a measurement including the first electronic device and the second electronic device; and transmitting the tuned output audio signal to speakers of the first electronic device for playback. In some embodiments, the parameter comprises at least one of an output audio level difference, a synchronization difference, or a physical distance between the first electronic device and the second electronic device. In some embodiments, the parameter comprises background noise in a physical environment that includes both the first electronic device and the second electronic device. In some embodiments, tuning the output audio signal comprises changing at least one of a dynamic range compression or equalization. In some embodiments, the speakers include a left speaker and a right speaker of a headset connected to the first electronic device, and the method further includes ducking either the left speaker or the right speaker based on detecting a voice of the second user in a physical environment that includes both the first electronic device and the second electronic device. In some embodiments, the speakers include virtual speakers in a spatial environment surrounding the first user, and the method further includes attenuating a gain of one or more of the virtual speakers relative to other virtual speakers in the spatial environment based on a location or direction of the second electronic device or the second user. In some embodiments, the method may include playing, via speakers of the first electronic device, a plurality of reflections to mask an echo caused by a voice of the second user or the second electronic device as picked up by a microphone of the first electronic device. In some embodiments, the method may include modifying an output to one or more virtual speakers of a plurality of virtual speakers surrounding the first user in a spatial environment.

Some implementations may include a method performed by a first electronic device, comprising determining by a first electronic device used by a first user whether a second electronic device that is being used by a second user is located within a threshold distance of the first electronic device, wherein the first electronic device is presenting a first XR environment to the first user and the second electronic device is presenting a second XR environment to the second user; and in response to the second electronic device being located within the threshold distance, playing, via speakers of the first electronic device, a plurality of reflections to mask an echo caused by a voice of the second user or the second electronic device as picked up by a microphone of the first electronic device. In some embodiments, the plurality of reflections include one or more early reflections before the echo and one or more late reflections after the echo. In some embodiments, the plurality of reflections include one or more positive reflections with the echo and one or more negative reflections opposing the echo. In some embodiments, the plurality of reflections is determined based on a physical distance between the first electronic device and the second electronic device. In some embodiments, the speakers are virtual speakers in a spatial environment surrounding the first user, and wherein a gain of one or more of the virtual speakers is reduced relative to other virtual speakers in the spatial environment based on a location or direction of the voice.

Some implementations may include a method performed by a first electronic device, comprising determining by a first electronic device used by a first user a location or direction of a sound source emitting a sound to the first user, wherein the first electronic device is presenting a first XR environment to the first user; and in response to the sound source emitting the sound, modifying an output to one or more virtual speakers of a plurality of virtual speakers surrounding the first user in a spatial environment, relative to other virtual speakers of the plurality of virtual speakers, based on a location or direction of the sound source. In some embodiments, the sound source is a notification window in the first XR environment. In some embodiments, the sound source is a second user of a second electronic device presenting a second XR environment that is connected to the first XR environment. In some embodiments, the one or more virtual speakers define a virtual cone oriented toward the location or direction, and wherein modifying the output causes gains to the one or more virtual speakers to be attenuated differently based on positions of the one or more virtual speakers in the virtual cone. In some embodiments, positions of the one or more virtual speakers are moved outward relative to the first user to enable a pathway for direct sound from the sound source.

As described above, one aspect of the present technology is the gathering and use of data available from specific and legitimate sources for acoustics processing for nearby spatial audio in XR environments. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used for acoustics processing for nearby spatial audio in XR environments. Accordingly, use of such personal information data enables users to have greater control of the delivered content.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the U.S., collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, such as in the case of acoustics processing for nearby spatial audio in XR environments, the present technology can be configured to allow users to select to “opt in” or “opt out” of participation in the collection of personal information data during registration for services or anytime thereafter.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users based on aggregated non-personal information data or a bare minimum amount of personal information, such as the content being handled only on the user's device or other non-personal information available to the content delivery services.

In utilizing the various aspects of the embodiments, it would become apparent to one skilled in the art that combinations or variations of the above embodiments are possible for acoustics processing for nearby spatial audio in XR environments. Although the embodiments have been described in language specific to structural features and/or methodological acts, it is to be understood that the appended claims are not necessarily limited to the specific features or acts described. The specific features and acts disclosed are instead to be understood as embodiments of the claims useful for illustration.

What is claimed is:

1. A method performed by a first electronic device, comprising:
determining by a first electronic device used by a first user whether a second electronic device that is being used by a second user is located within a threshold distance of the first electronic device, wherein the first electronic device is presenting a first extended reality (XR) environment to the first user and the second electronic device is presenting a second XR environment to the second user; and
in response to the second electronic device being located within the threshold distance, playing via speakers of the first electronic device, in the first XR environment being presented to the first user, a voice of the second user with a sound adjustment.

2. The method of claim 1, wherein the sound adjustment a) suppresses a direct path of the voice of the second user as picked up by a microphone of the second electronic device, and b) adds or retains a reverberation tail of the voice of the second user.

3. The method of claim 1, wherein the first XR environment is different from the second XR environment, and wherein the sound adjustment modifies a reverberation tail of the voice of the second user, as picked up by a microphone of the second electronic device, to simulate acoustically that the second user is talking in the first XR environment.

4. The method of claim 1, wherein the sound adjustment includes a reverberation tail of the voice of the second user that is time-aligned with a voice of the second user in a physical environment that includes both the first electronic device and the second electronic device.

5. The method of claim 1, wherein the sound adjustment suppresses a direct path of the voice of the second user to either a left speaker or a right speaker of a headset connected to the first electronic device based on a location or direction of the second electronic device or the second user.

6. The method of claim 1, wherein the sound adjustment includes a reverberation tail of the voice of the second user superimposed with a physical reverberation of the voice of the second user in a physical environment that includes both the first electronic device and the second electronic device.

7. The method of claim 1, further comprising:
playing, in response to a third electronic device used by a third user being located outside of the threshold distance, a direct path followed by a reverberation tail of a voice of the third user in the first XR environment.

8. The method of claim 1, wherein the speakers are virtual speakers in a spatial environment surrounding the first user, and wherein an output to one or more of the virtual speakers is modified relative to other virtual speakers in the spatial environment based on a location or direction of the second electronic device or the second user.

9. A method performed by a first electronic device, comprising:
synchronizing content for playback on a first electronic device used by a first user with the content being played back on a second electronic device that is being used by a second user to within a level of synchronization, wherein the first electronic device is presenting a first XR environment to the first user and the second electronic device is presenting a second XR environment to the second user, and wherein the first electronic device and the second electronic device are in a common physical environment;
determining by the first electronic device whether the second electronic device is located within a threshold distance of the first electronic device; and
in response to the second electronic device being located within the threshold distance, adjusting, based on background noise measured in the common physical environment, the level of synchronization between the first electronic device and the second electronic device.

10. The method of claim 9, wherein the level of synchronization is adjusted by changing from a first networking protocol to a second networking protocol for communication between the first electronic device and the second electronic device.

11. The method of claim 9, wherein the level of synchronization is loosened or lowered with more background noise and tightened or raised with less background noise.

12. The method of claim 9, wherein loosening or lowering the level of synchronization enables a reduction in power consumption by the first electronic device.

13. A method performed by a first electronic device, comprising:
determining by a first electronic device used by a first user whether a second electronic device that is being used by a second user is located within a threshold distance of the first electronic device, wherein the first electronic device is presenting a first XR environment to the first user and the second electronic device is presenting a second XR environment to the second user;
in response to the second electronic device being located within the threshold distance, tuning an output audio signal based on a parameter having a measurement including the first electronic device and the second electronic device; and
transmitting the tuned output audio signal to speakers of the first electronic device for playback.

14. The method of claim 13, wherein the parameter comprises at least one of an output audio level difference, a synchronization difference, or a physical distance between the first electronic device and the second electronic device.

15. The method of claim 13, wherein the parameter comprises background noise in a physical environment that includes both the first electronic device and the second electronic device.

16. The method of claim 13, wherein tuning the output audio signal comprises changing at least one of a dynamic range compression or equalization.

17. The method of claim 13, wherein the speakers include a left speaker and a right speaker of a headset connected to the first electronic device, and further comprising:
ducking either the left speaker or the right speaker based on detecting a voice of the second user in a physical environment that includes both the first electronic device and the second electronic device.

18. The method of claim 13, wherein the speakers include virtual speakers in a spatial environment surrounding the first user, and further comprising:
attenuating a gain of one or more of the virtual speakers relative to other virtual speakers in the spatial environment based on a location or direction of the second electronic device or the second user.

19. The method of claim 13, further comprising:
playing, via speakers of the first electronic device, a plurality of reflections to mask an echo caused by a voice of the second user or the second electronic device as picked up by a microphone of the first electronic device.

20. The method of claim 13, further comprising:
modifying an output to one or more virtual speakers of a plurality of virtual speakers surrounding the first user in a spatial environment.
